(19) United States
(12) Patent Application Publication
(10) Pub. No.: US 2026/0200654 A1
(43) Pub. Date: Jul. 16, 2026

(54) SPOUTED PACKAGING BAG AND METHOD FOR PRODUCING SPOUTED PACKAGING BAG

(71) Applicant: TOPPAN Holdings Inc., Tokyo (JP)

(72) Inventors: Shiho SASSA, Tokyo (JP); Hiroyuki OTSUKA, Tokyo (JP); Haruka GODA, Tokyo (JP)

(73) Assignee: TOPPAN Holdings Inc., Tokyo (JP)

(21) Appl. No.: 19/135,657

(22) PCT Filed: Jan. 25, 2024
(86) PCT No.: PCT/JP2024/002301

§ 371 Date: Jun. 4, 2025

(30) Foreign Application Priority Data
Feb. 1, 2023 (JP) 2023-014224

(51) Int. Cl. B65D 75/58; B31B 70/84; B31B 155/00; B31B 170/20

(52) U.S. Cl. CPC B65D 75/5883; B31B 70/844; B31B 2155/002; B31B 2170/20; B65D 2575/583

(57) ABSTRACT

A spouted packaging bag includes a storage portion made of laminated films each having a base material and a sealant layer made of the same material, and a spout having a spout tube and a base provided on one end side of the spout tube, and attached to an upper end portion of the storage portion. At the upper end portion of the storage portion, the sealant layer is welded to the base of the spout, and the sealant layers are welded to each other at a side of the base. In the spouted packaging bag, a width of a first welding region where the sealant layer is welded to the base is shorter than a width of a second welding region where the sealant layers are welded to each other, and a step is formed between the first welding region and the second welding region.

### TECHNICAL FIELD

The present invention relates to a spouted packaging bag and a method for producing a spouted packaging bag.

### BACKGROUND ART

A spouted packaging bag that stores predetermined contents (for example, liquid detergent or shampoo) and from which the stored contents can be poured out as necessary is known. As a packaging material constituting the packaging bag, a laminated film having a multi-material configuration and including a sealant layer made of polyolefin or the like and a base material made of a material (polyester or the like) having a higher melting point than the sealant layer is used. In recent years, from the viewpoint of environmental consideration, efforts have been made to convert packaging materials into mono-materials, and it has been studied to use, as a packaging material, a laminated film containing polypropylene or the like as a main constituent material instead of the laminated film having a multi-material configuration (see, for example, Patent Literature 1).

### CITATION LIST

### Patent Literature

Patent Literature 1: Japanese Unexamined Patent Publication No. 2020-157517

Patent Literature 2: Japanese Unexamined Patent Publication No. 2017-065747

Patent Literature 3: Japanese Unexamined Patent Publication No. 2010-511634

Patent Literature 4: Japanese Unexamined Patent Publication No. 2013-177531

### SUMMARY OF INVENTION

### Technical Problem

In a case where the spouted packaging bag is made using a laminated film having a mono-material configuration, since the melting point of the material constituting the sealant layer is equivalent to the melting point of the material constituting the base material, it is necessary to lower a temperature at which the sealant layer is welded to a spout as compared with the case of making the spouted packaging bag using the laminated film having a multi-material configuration. However, when the welding temperature is lowered, the welding of the sealant layer and the spout becomes insufficient accordingly, and the sealing strength of a portion where the sealant layer is welded to the spout may be lowered. For this reason, in a case where the spouted packaging bag is made using the laminated film having a mono-material configuration, there is a possibility that a pressure resistance strength when the contents are filled in the packaging bag is reduced.

An object of the present invention is to provide a spouted packaging bag capable of improving a pressure resistance strength even when a laminated film having a mono-material configuration is used, and a method for producing the spouted packaging bag.

### Solution to Problem

[1] As one aspect, the present invention relates to a spouted packaging bag. The spouted packaging bag includes a storage portion made of laminated films each having a base material and a sealant layer that are made of the same material, and a spout having a spout tube extending in a first direction and a base provided on one end side of the spout tube, and attached to an edge portion of the storage portion. At the edge portion of the storage portion, the sealant layer is welded to the base of the spout, and the sealant layers are welded to each other at a side of the base. In the spouted packaging bag, the width of a first welding region where the sealant layer is welded to the base, along the first direction, is shorter than the width of a second welding region where the sealant layers are welded to each other, along the first direction, and a step is formed between the first welding region and the second welding region.

In the spouted packaging bag, the step is provided between the first welding region where the sealant layer is welded to the base of the spout and the second welding region where the sealant layers are welded to each other. By providing such a step, when heat is applied (at the time of producing) to a portion of the laminated film having a mono-material configuration and located at a portion (step) below the spout, the film portion is softened and deformed so as to be narrowed inward (see FIG. 5). According to the study of the present inventors, the laminated film has such a recessed (narrowed) configuration, and therefore, when the contents are stored in the packaging bag, the pressure of the contents which should be applied to a portion (an end portion of the spout) where the sealant layer is welded to the spout is less likely to be applied, the stress is dispersed in portions other than the portion, and the pressure is guided toward a region where the sealant layer located at the side of the spout is welded to each other (see (b) of FIG. 7). The second welding region of the sealant layer has a higher sealing strength than the first welding region where the sealant layer is welded to the spout (base). Therefore, according to the spouted packaging bag, the pressure resistance strength can be improved even when the laminated film having a mono-material configuration is used.

[2] In the spouted packaging bag according to [1], the size of the step along the first direction is preferably 1.5 mm or more. In this case, the portion of the laminated film located at the portion (step) below the spout can be more reliably deformed so as to be narrowed inward to achieve pressure dispersion. Therefore, according to the spouted packaging bag, the pressure resistance strength can be more reliably improved even when the laminated film having a mono-material configuration is used.

[3] In the spouted packaging bag according to [1] or [2], the size of the step along the first direction is preferably 5 mm or less. The step portion between the first welding region where the sealant layer is welded to the base of the spout and the second welding region where the sealant layers ares welded to each other, constitutes a flow path for pouring the contents stored in the storage portion out of the spout tube of the spout. As described above, the portion of the laminated film corresponding to the step is narrowed inward, and the flow path is narrowed. For this reason, in the spouted packaging bag, the length of the step is set to 5 mm or less. Therefore, according to the spouted packaging bag, the contents stored in the packaging bag can be easily poured out.

[4] In the spouted packaging bag according to any of [1] to [3], the size of the step along the first direction may be 0.15 to 0.6 with respect to the length of the base along the first direction. In this case, since the size of the step is 0.15 or more with respect to the length of the base, the portion of the laminated film located at the portion (step) below the spout is deformed so as to be narrowed inward to achieve pressure dispersion in the same manner as described above, whereby the pressure resistance strength can be more reliably improved even when the laminated film having a mono-material configuration is used. In addition, since the size of the step is 0.6 or less with respect to the length of the base, it is possible to easily pour out the contents stored in the packaging bag without making the flow path too long in the same manner as described above.

[5] In the spouted packaging bag according to any of [1] to [4], the size of the step along the first direction may be 0.1 to 0.5 with respect to the lateral width of the base along a second direction intersecting the first direction. In this case, since the size of the step is 0.1 or more with respect to the lateral width of the base, the portion of the laminated film located at the portion (step) below the spout is deformed so as to be narrowed inward to achieve pressure dispersion in the same manner as described above, whereby the pressure resistance strength can be more reliably improved even when the laminated film having a mono-material configuration is used. In addition, since the size of the step is 0.5 or less with respect to the lateral width of the base, it is possible to easily pour out the contents stored in the packaging bag without making the flow path too long in the same manner as described above.

[6] In the spouted packaging bag according to any of [1] to [5], the same material constituting the base material and the sealant layer is preferably a polyethylene resin or a polypropylene resin. By using such a material, softening at the time of welding is easily accelerated, and when heat is applied to the portion of the laminated film located at the portion (step) below the spout, the portion of the film can be more reliably deformed so as to be narrowed inward. As a result, the pressure resistance strength can be improved even when the laminated film having a mono-material configuration is used.

[7] In the spouted packaging bag according to any of [1] to [6], the same material constituting the base material and the sealant layer may be a polyethylene resin, and the content of the polyethylene resin in the entire laminated films may be 90 mass % or more. In this case, softening at the time of welding is more easily accelerated, and when heat is applied to the portion of the laminated film located at the portion (step) below the spout, the portion of the film can be more reliably deformed so as to be narrowed inward. As a result, the pressure resistance strength can be improved even when the laminated film having a mono-material configuration is used. In addition, in this case, recyclability can also be enhanced.

[8] In the spouted packaging bag according to any of [1] to [7], the storage portion is preferably formed such that the sealant layers facing each other are recessed inward at the step between the first welding region and the second welding region. In this case, even when the contents are stored in the packaging bag and pressure is applied, the pressure is less likely to be applied to the first region (the end portion of the spout) where the sealant layer is welded to the spout, and the pressure is dispersed so as to be applied to the portion where the sealant layers are welded to each other. Therefore, according to the spouted packaging bag, the pressure resistance strength can be improved even when the laminated film having a mono-material configuration is used.

[9] As another aspect, the present invention relates to a method for producing a spouted packaging bag. This method for producing a spouted packaging bag includes, preparing laminated films each having a base material and a sealant layer made of the same material; preparing a spout having a spout tube and a base provided on one end side of the spout tube; and welding the sealant layer of the laminated film to the base of the spout and welding the sealant layers to each other at a side of the base. In the welding, welding is performed such that the width of a first welding region where the sealant layer is welded to the base is shorter than the width of a second welding region where the sealant layers are welded to each other, and a step is formed between the first welding region and the second welding region.

In the method for producing a spouted packaging bag, in the welding, welding is performed such that the width of the first welding region where the sealant layer is welded to the base is shorter than the width of the second welding region where the sealant layers are welded to each other, and the step is formed between the first welding region and the second welding region. By providing the step in this manner, when heat is applied to a portion of the laminated film having a mono-material configuration and located at a portion (step) below the spout, the portion of the film is softened and deformed so as to be narrowed inward. The film has such a recessed (narrowed) configuration, and therefore, even when the contents are stored in the packaging bag and pressure is applied, the pressure is less likely to be applied to the first welding region (an end portion of the spout) where the sealant layer is welded to the spout, and the pressure is directed to the second welding region where the sealant layers are welded to each other. Therefore, according to the method for producing a spouted packaging bag, it is possible to obtain a packaging bag having improved pressure resistance strength even when the laminated film having a mono-material configuration is used. In addition, it has been found by the study of the present inventors that when it is attempted to produce a spouted packaging bag in which a step is not provided as in the conventional configuration with the laminated film having a mono-material configuration, the producing conditions (condition range of a sealing temperature) for setting the sealing strength and the pressure resistance strength to predetermined values or more are extremely narrow (see Comparative Example described later). For this reason, in the producing method with the conventional configuration, productivity is reduced. However, according to this producing method, since the range of the producing conditions for setting the sealing strength and the pressure resistance strength to the predetermined values or more can be widened, it is possible to improve the productivity and also increase a non-defective product rate.

[10] In the method for producing a spouted packaging bag according to [9], the width of the step is preferably 1.5 mm to 5 mm. Since the width of the step is 1.5 mm or more, the portion of the laminated film located at the portion (step) below the spout can be more reliably deformed so as to be narrowed inward. As a result, according to the spouted packaging bag, the pressure resistance strength can be more reliably improved even when the laminated film having a mono-material configuration is used. On the other hand, since the width of the step is 5 mm or less, it is possible to easily pour out the contents stored in the packaging bag by limiting the length of the narrow flow path as described above.

### Advantageous Effects of Invention

According to the present invention, it is possible to provide a spouted packaging bag and a method for producing a spouted packaging bag, in which the pressure resistance strength is improved even when a laminated film having a mono-material configuration is used.

### BRIEF DESCRIPTION OF DRAWINGS

FIG. 1 is a front view illustrating a spouted packaging bag according to an embodiment.

FIG. 2 is a cross-sectional view illustrating a cross section of a laminated film constituting the spouted packaging bag illustrated in FIG. 1.

(a) of FIG. 3 is a front view illustrating a spout used in the spouted packaging bag illustrated in FIG. 1, and (b) of FIG. 3 is a cross-sectional view of the spout as viewed from below (base side).

FIG. 4 is an enlarged front view illustrating the vicinity of a welded portion of the spout in the spouted packaging bag illustrated in FIG. 1.

FIG. 5 is a cross-sectional view illustrating a cross section of the vicinity of the welded portion of the spout illustrated in FIG. 4.

(a) of FIG. 6 is an enlarged front view illustrating the vicinity of a welded portion of a spout in a spouted packaging bag according to Comparative Example, and (b) of FIG. 6 is a cross-sectional view of (a) of FIG. 6.

(a) of FIG. 7 is a diagram for explaining pressure applied when the contents (liquid) are filled in the spouted packaging bag according to Comparative Example, and (b) of FIG. 7 is a diagram for explaining pressure applied when the contents (liquid) are filled in the spouted packaging bag according to the present embodiment.

FIG. 8 is a diagram illustrating an example of a test piece used for a sealing strength test.

### DESCRIPTION OF EMBODIMENTS

Hereinafter, a spouted packaging bag according to an embodiment of the present invention will be described in detail with reference to the drawings. In the description, the same reference numerals may be used for the same elements or elements having the same functions, and redundant description will be omitted. Note that the present invention is not limited to the following embodiment.

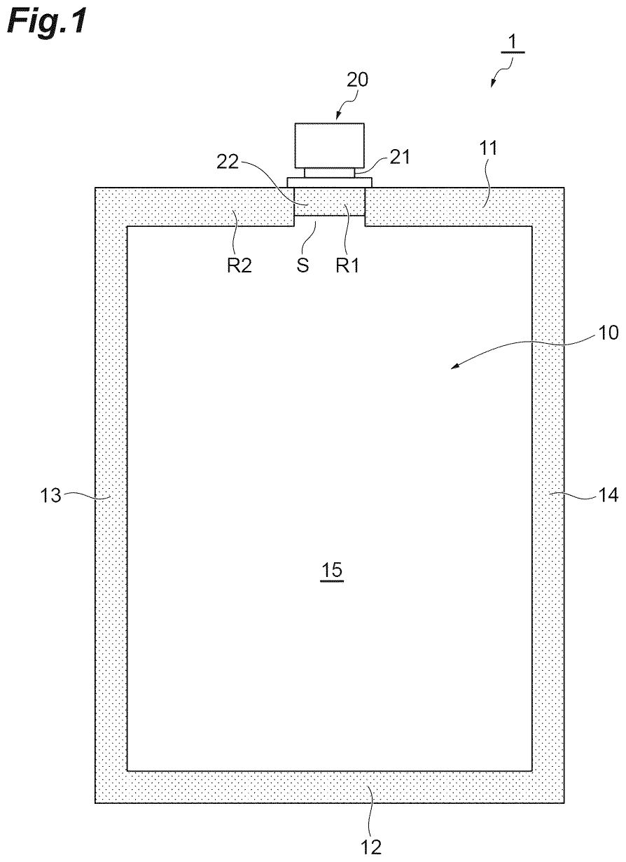

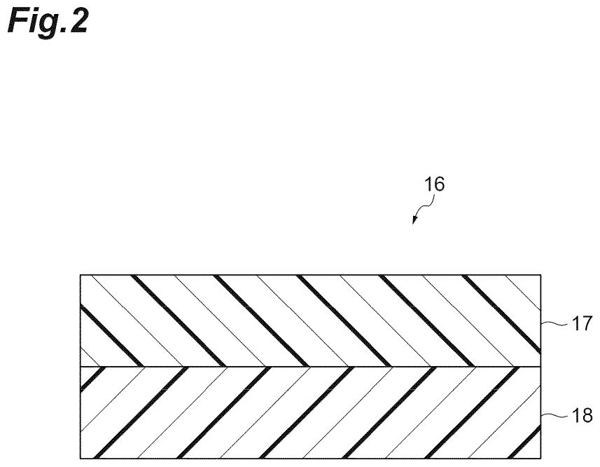

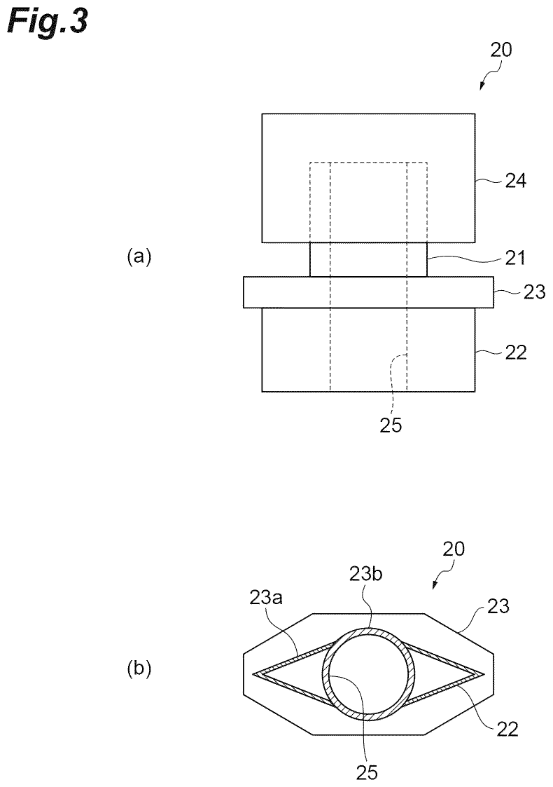

FIG. 1 is a plan view illustrating a spouted packaging bag according to one embodiment. As illustrated in FIG. 1, the spouted packaging bag 1 includes a storage portion 10 made of a laminated film having a mono-material configuration, and a spout 20 attached to an upper end portion 11 (edge portion) of the storage portion 10. The storage portion 10 constitutes a bag portion of the spouted packaging bag 1, and is configured such that a storage region 15 of contents is surrounded by the upper end portion 11, a lower end portion 12, and side portions 13 and 14 formed by welding (sealing) sealant layers 18 (see FIG. 2) of the laminated films 16 to each other. In the storage region 15 of the storage portion 10, for example, liquid detergent, shampoo, or the like is stored. The contents stored in the storage portion 10 can be poured out of the spout 20. Note that such a spouted packaging bag may be a so-called standing pouch.

FIG. 2 is a diagram illustrating a cross section of the laminated film constituting the storage portion 10 of the spouted packaging bag 1. As illustrated in FIG. 2, the laminated film 16 constituting the storage portion 10 is a laminated film having a mono-material configuration, and has a base material 17 and the sealant layer 18 that are made of the same material. As the same material constituting the base material 17 and the sealant layer 18, for example, a polyethylene resin or a polypropylene resin can be used. In addition, in order to form the storage portion 10 from the laminated film 16, a plurality of such laminated films 16 are prepared, and welding of the upper end portion 11, the lower end portion 12, and the side portions 13 and 14 is performed such that the respective sealant layers 18 of the laminated films face inward to form a bag shape as illustrated in FIG. 1. Note that the term “same material” as used herein does not mean only completely the same material, but includes materials having the same main constituent material.

### [Base Material]

The base material 17 is made of, for example, a polyethylene resin or a polypropylene resin. When the base material 17 is an unstretched polyethylene resin film, there is almost no orientation of the resin, and the base material is easily stretched against external stress such as tensile or shearing and is less likely to be broken. When the base material 17 is a stretched polyethylene resin film, it is excellent in piercing resistance. The thickness of the base material 17 is, for example, 5 to 800 μm, and may be 5 to 500 μm or 10 to 50 μm. The base material 17 has a melting point higher by 20° C. or more than that of the sealant layer 18, and preferably may have a melting point higher by 25° C. or more than that of the sealant layer 18. Since there is a difference in melting point between the two, melting of the base material 17 can be suppressed in a heat-sealing step. A difference in sealing rising temperature between the base material 17 and the sealant layer 18 is preferably 25° C. or more, and more preferably 30° C. or more. The sealing rising temperature means a temperature at which the sealing strength is developed. The melting point of the polyethylene resin can be measured using a differential scanning calorimeter (DSC).

The melting point of the base material 17 is, for example, within a range of 100 to 170° C., preferably 120° C. or more, and more preferably 125° C. or more. Examples of the polyethylene constituting the base material 17 include high-density polyethylene (HDPE) and medium-density polyethylene (MDPE). Among them, from the viewpoint of heat resistance, it is preferable to use HDPE and MDPE having a density of 0.925 g/cm³ or more. In particular, it is preferable to use high-density polyethylene having a density in a range of 0.93 to 0.98 g/cm³.

The polyethylene resin constituting the base material 17 is not limited to a petroleum-derived resin, and a part or the whole thereof may be a bio-derived resin material (for example, biomass polyethylene using biomass-derived ethylene as a raw material). A method for producing a biomass-derived polyethylene is disclosed in, for example, Japanese Unexamined Patent Publication No. 2010-511634. The base material 17 may contain a commercially available biomass polyethylene (green PE manufactured by Braschem, and the like), or may contain a mechanical recycled polyethylene using, as a raw material, a used polyethylene product or a resin (so-called burr) generated in the process of producing a polyethylene product.

The base material 17 may contain a component other than a polyethylene resin. Examples of the component include polyamide, polyethylene terephthalate, polypropylene, polyvinyl alcohol, and a biodegradable resin material (for example, polylactic acid, polycaprolactone, polyhydroxyalkanoate, polyglycolic acid, modified polyvinyl alcohol, casein, modified starch, and the like). The base material 17 may contain an additive such as an antistatic agent, an ultraviolet absorber, a plasticizer, a lubricant, and a colorant. The amount of components other than the polyethylene resin in the base material 17 is preferably 15 mass % or less, and more preferably 10 mass % or less, based on the total amount of the base material 17.

### [Sealant Layer]

Similarly to the base material 17, the sealant layer 18 is made of a polyethylene resin film. That is, the sealant layer 18 is made of the same material as the base material 17. Note that the same material as used herein is sufficient as long as a main resin (for example, polyethylene resin) is the same, and includes a case where components contained other than the main resin are different. The thickness of the sealant layer 18 is, for example, 40 to 150 μm, and may be 20 to 250 μm. The polyethylene resin film constituting the sealant layer 18 is a film imparted with easy tearability in a machine direction (MD direction).

The polyethylene resin constituting the sealant layer 18 having such easy tearability is preferably, for example, C4-LLDPE. C4-LLDPE is a kind of LLDPE (linear low-density polyethylene) composed of a copolymer of ethylene and 1-butene, and has a molecular structure having a side chain having 4 carbon atoms derived from 1-butene in a main chain of an ethylene-derived LLDPE. C4-LLDPE has a shorter side chain and a lower melt flow rate (MFR) than C6-LLDPE and C8-LLDPE, and thus has relatively low tensile impact strength, tensile strength, and tensile modulus. For this reason, when the polyethylene resin constituting the sealant layer 18 is C4-LLDPE, easy tearability can be easily imparted in the machine direction of the sealant layer 18.

The melt flow rate (MFR) of the sealant layer 18 is less than 5 g/10 min, preferably 0.5 g/10 min or more and less than 5 g/10 min, and more preferably 2 g/10 min or more and less than 5 g/10 min. Since the melt flow rate is less than 5 g/10 min, the melt tension is increased, and an effect of easily suppressing wrinkles during processing by an inflation method or the like is exhibited. That is, the sealant layer 18 is slightly less likely to flow when heated for melting, so that a smooth and transparent film can be obtained.

The melting point of the sealant layer 18 is, for example, within a range of 100 to 170° C., preferably 120° C. or less, and more preferably 95 to 110° C. The sealant layer 18 is preferably made of a polyethylene resin having a density of less than 0.925 g/cm³ (more preferably 0.900 to 0.920 g/cm³). As an example, the linear low-density polyethylene (LLDPE) described above can be used, and very-low-density polyethylene (VLDPE) may be used, or a blend of LLDPE and VLDPE may be used as long as easy tearability can be imparted in the machine direction of the sealant layer 18.

As a part or the whole of the polyethylene constituting the sealant layer 18, biomass polyethylene using biomass-derived ethylene as a raw material may be used. Such a sealant film is disclosed in, for example, Japanese Unexamined Patent Publication No. 2013-177531. The sealant layer 18 may contain a mechanical recycled polyethylene using, as a raw material, a used polyethylene product or a resin (so-called burr) generated in the process of producing a polyethylene product.

### (Other Layers)

The laminated film 16 may include an adhesive layer (not illustrated) between the base material 17 and the sealant layer 18. An adhesive for forming the adhesive layer can be selected according to a bonding method, but a urethane-based adhesive, a polyester-based adhesive, or the like can be used. By providing such an adhesive layer, the interlayer adhesion between the base material 17 and the sealant layer 18 is increased, so that delamination is less likely to occur, and pressure resistance and impact resistance as a pouch can be maintained.

The adhesive layer preferably does not contain chlorine. Since the adhesive layer does not contain chlorine, it is possible to prevent coloring of the adhesive or a recycled resin after recycling and generation of an odor due to heat treatment. It is preferable from the viewpoint of environmental consideration to use a biomass material for the adhesive layer. In addition, as the polyethylene, biomass polyethylene can be used. From the viewpoint of environmental consideration, it is preferable that the adhesive does not contain a solvent.

The laminated film 16 may further include a gas barrier layer, for example, from the viewpoint of improving a gas barrier property against water vapor and oxygen. The gas barrier layer may be provided between the base material 17 and the sealant layer 18, or may be provided on a surface of the base material 17 opposite to the sealant layer 18. The water vapor transmission amount of a laminate is, for example, 5 g/m²·day, and may be 1 g/m²·day or less or 0.5 g/m²·day or less. The oxygen transmission amount of the laminated film 16 is, for example, 1 cc/m²·atm·day, and may be 0.5 g/m²·atm·day or less or 0.2 g/m²·atm·day or less. When the laminated film 16 includes the gas barrier layer, the contents are protected from deterioration due to water vapor or oxygen, and quality is easily maintained for a long period of time.

An example of the gas barrier layer is a vapor-deposited layer of an inorganic oxide. By using the vapor-deposited layer of an inorganic oxide, a high barrier property can be obtained with a very thin layer to such an extent that does not affect the recyclability of the laminate. Examples of the inorganic oxide include aluminum oxide, silicon oxide, magnesium oxide, and tin oxide. From the viewpoint of transparency and barrier properties, the inorganic oxide may be selected from the group consisting of aluminum oxide, silicon oxide, and magnesium oxide. The thickness of the vapor-deposited layer of the inorganic oxide can be, for example, 5 nm or more and 100 nm or less, and may be 10 nm or more and 50 nm or less. Since the thickness is 5 nm or more, the barrier properties are easily exhibited well, and since the thickness is 100 nm or less, the flexibility of the laminate is easily maintained. The vapor-deposited layer can be formed by, for example, a physical vapor deposition method, a chemical vapor deposition method, or the like.

The laminated film 16 may include a metal layer (metal foil) instead of or in addition to the vapor-deposited layer of the inorganic oxide. As the metal layer, various metal foils made of aluminum, stainless steel, or the like can be used, and among these, an aluminum foil is preferable from the viewpoint of moisture resistance, workability such as spreadability, cost, and the like. As the aluminum foil, a general soft aluminum foil can be used. In particular, an aluminum foil containing iron is preferable from the viewpoint of excellent pinhole resistance and spreadability during molding. When the metal layer is provided, the thickness thereof may be 7 to 50 μm or 9 to 15 μm from the viewpoint of barrier properties, pinhole resistance, workability, and the like.

The laminated film 16 may include an anchor coat layer between the base material 17 and the sealant layer 18. The anchor coat layer may be a very thin layer to such an extent that does not affect the recyclability of the laminated film 16, and can be formed using an anchor coat agent. Examples of the anchor coat agent include an acrylic resin, an epoxy resin, an acrylic urethane-based resin, a polyester-based polyurethane resin, a polyether-based polyurethane resin, and a polyvinyl alcohol-based resin. The anchor coat agent is preferably an acrylic urethane-based resin or a polyester-based polyurethane resin from the viewpoint of heat resistance and interlayer adhesion strength.

The laminated film 16 may further include, for example, a printing layer. The printing layer may be provided between the base material 17 and the sealant layer 18, or may be provided on the surface of the base material 17 opposite to the sealant layer 18. When the printing layer is provided, it is preferable to use a printing ink that does not contain chlorine from the viewpoint of preventing the printing layer from being colored or generating an odor at the time of remelting. In addition, it is preferable from the viewpoint of environmental consideration to use a biomass material as a compound contained in the printing ink.

Next, with reference to FIGS. 1 and 3, the spout 20 attached to the upper end portion 11 of the storage portion 10 made of the laminated film(s) 16 will be described. (a) of FIG. 3 is a front view illustrating the spout 20 used in the spouted packaging bag 1, and (b) of FIG. 3 is a diagram of the spout 20 as viewed from below (base side). As illustrated in FIGS. 1 and 3, the spout 20 includes a spout tube 21 extending in one direction (first direction, vertical direction in FIG. 1 and (a) of FIG. 3), a base 22 provided on one end (lower end) side of the spout tube 21, a flange 23 provided between the spout tube 21 and the base 22, and a cap 24 screwed with a male screw provided on the outside of the spout tube 21 to close the other end (upper end) of the spout tube 21. Inside from the upper end of the spout tube 21 to the lower end of the base 22, a spout path 25 penetrating the center is provided. As a result, the contents filled in the spouted packaging bag 1 can be poured out to the outside of the bag. Note that similarly to the laminated film(s) 16 described above, the spout 20 can be formed of, for example, a polyethylene resin.

As illustrated in (b) of FIG. 3, the base 22 has, for example, a triangular portion 23a and an arc-shaped portion 23b, and the spout path 25 described above is formed inside the base. The base 22 is a portion to which the sealant layers 18 of the laminated films 16 are welded when the spout 20 is attached to the storage portion 10, and the sealant layers 18 are welded to each other at both sides of the base 22. Note that a plurality of ribs for supporting the welding of the sealant layers 18 may be provided on the front surface side of the base 22 where the sealant layers 18 are welded. Such ribs may, for example, extend in a lateral direction.

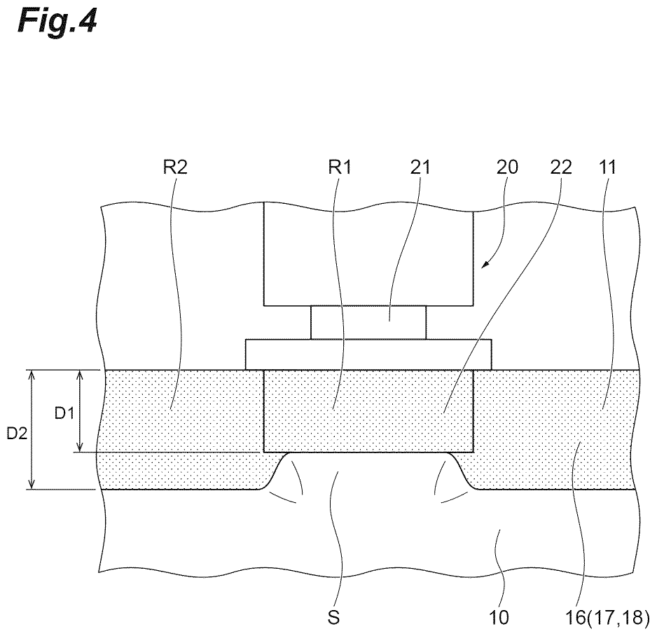

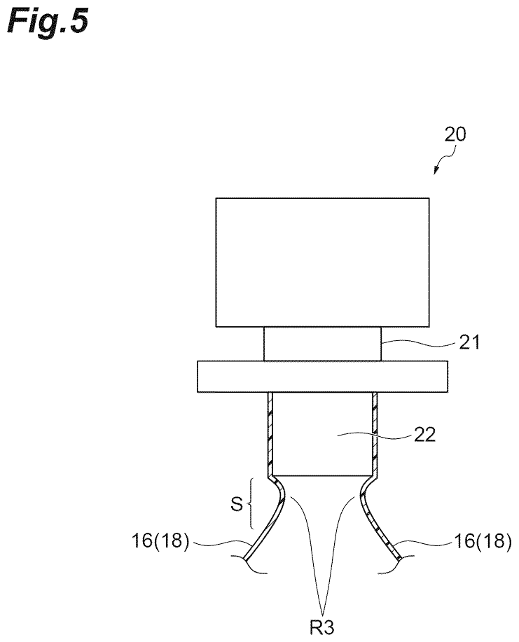

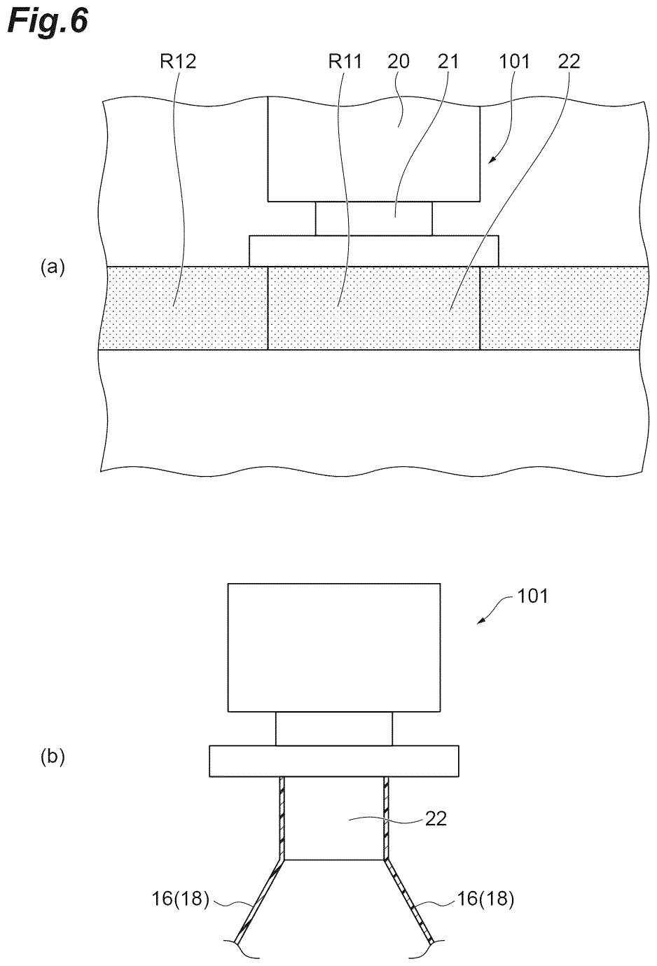

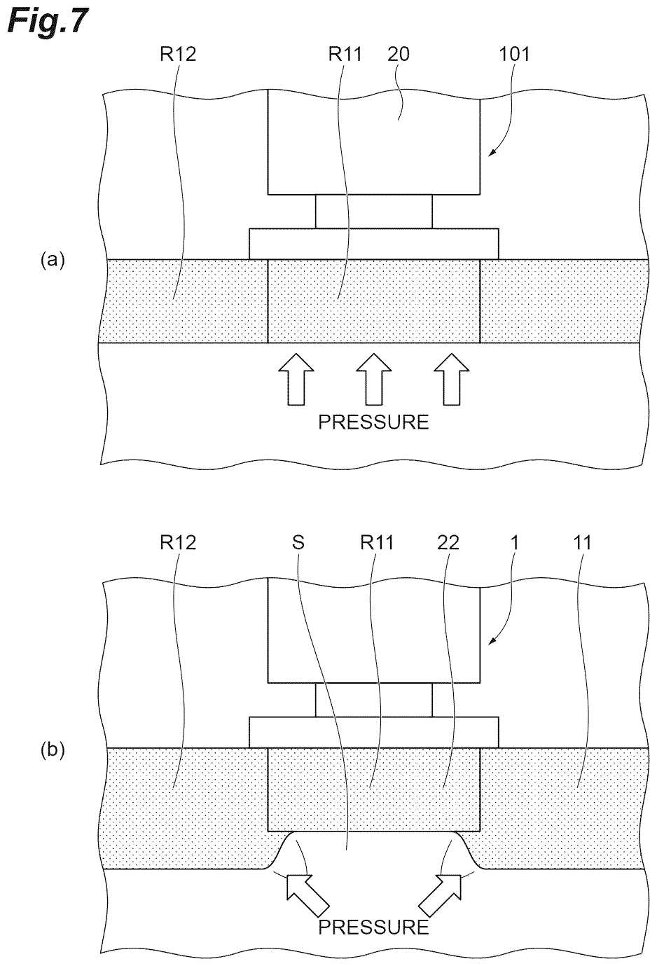

Here, the configuration of a region where the spout 20 is welded to the laminated films 16 will be described in detail with reference to FIGS. 4 and 5. FIG. 4 is an enlarged front view illustrating the vicinity of a welded portion of the spout 20 in the spouted packaging bag 1. As illustrated in FIG. 4, in the spouted packaging bag 1 according to the present embodiment, at the upper end portion 11 of the storage portion 10, the sealant layers 18 of the laminated films 16 are welded to the base 22 of the spout 20, and the sealant layers 18 are welded to each other at the sides (both edges) of the base 22. That is, in the welding of the spout 20, the sealant layers 18 are welded on the front surface side and the back surface side of the spout 20, and the facing sealant layers 18 are directly welded to each other at both sides of the spout 20.

In addition, in the spouted packaging bag 1 according to the present embodiment, a width D1 of a first welding region R1 where each sealant layer 18 is welded to the base 22, along the vertical direction, is shorter than a width D2 of a second welding region R2 where the sealant layers 18 are welded to each other, along the vertical direction, and a step S is formed between the first welding region R1 and the second welding region R2. The step S is, for example, a small step having a size of 1.5 mm or more and 5 mm or less along the vertical direction. In addition, the size of the step S along the vertical direction can also be defined as a ratio to the size of the base, and may be 0.15 to 0.6 with respect to the length (corresponding to D1) of the base 22 along the vertical direction, or may be 0.1 to 0.5 with respect to the lateral width of the base 22 along the lateral direction (second direction) orthogonal to (intersecting) the vertical direction. The length of the base 22 along the vertical direction is, for example, 7 to 12 mm, and the lateral width of the base 22 along the lateral direction is, for example, 15 to 45 mm. In this manner, the step S is a minute step with respect to the size and length of the base 22 or the like. Note that although an upper end of the first welding region R1 is along a lower end of the flange 23 of the spout 20 in FIG. 4, each laminated film 16 may be welded to the spout 20 such that the upper end of the first welding region R1 is slightly separated from the lower end of the flange 23.

Next, a cross-sectional shape of the packaging bag in the vicinity of the step S having such a minute size will be described with reference to FIG. 5. FIG. 5 is a cross-sectional view illustrating a cross section of the vicinity of the welded portion of the spout illustrated in FIG. 4. As illustrated in FIG. 5, in the laminated films 16, at the step S located below the spout 20 (base 22), the laminated films 16 (sealant layers 18) facing each other are recessed inward to form a recessed region R3. This is caused such that when each laminated film 16 is welded to the spout 20, the laminated film 16 at both ends of the spout 20 is heated in a state where pulling tension is applied to the laminated film to soften the film, and after the heating is finished, each film enters (shrinks) inside at both upper and lower side surfaces by the tension. Such a recessed region R3 protects a region where the spout 20 (base 22) and each sealant layer 18 of the laminated film 16 are welded to each other. Note that the laminated films 16 at the step S are not welded to each other.

Here, with reference to FIGS. 5 to 7, a difference in cross-sectional shape between a case where the step S is provided between the first welding region R1 and the second welding region R2 as in the present embodiment and a case where the step is not provided between the first welding region R1 and the second welding region R2 (Comparative Example) and functions and effects caused by the difference in shape will be described. (a) of FIG. 6 is an enlarged front view illustrating the vicinity of a welded portion of a spout in a spouted packaging bag according to a conventional example, and (b) of FIG. 6 is a cross-sectional view of (a) of FIG. 6. (a) of FIG. 7 is a diagram for explaining pressure applied when the contents (liquid) are filled in the spouted packaging bag according to the conventional example, and (b) of FIG. 7 is a diagram for explaining pressure applied when the contents (liquid) are filled in the spouted packaging bag according to the present embodiment.

As illustrated in FIG. 6, in the spouted packaging bag 101 according to the conventional example, welding is performed such that a step is not provided between a first welding region R11 where the sealant layers 18 of the laminated films 16 are welded to the spout 20 (base) and a second welding region R12 where the sealant layers 18 of the laminated films 16 are welded to each other. That is, the welding width of the first welding region R11 of the spout 20 is substantially the same as the welding width of the second welding region R2 where the sealant layers are welded to each other. In this case, the facing laminated films 16 (sealant layers 18) are not pulled to each other, and thus do not have a shape that is recessed (narrowed) inward like the spouted packaging bag 1 according to the present embodiment. In such a spouted packaging bag 101 according to the conventional example, as illustrated in (a) of FIG. 7, when the contents are stored in the spouted packaging bag 101 and pressure is applied, the pressure from the contents is uniformly applied to both the first welding region R11 and the second welding region R12. In such a spouted packaging bag 101 according to the conventional example, since the laminated films 16 having a mono-material configuration are used, it is difficult to increase the sealing strength in the vicinity of the spout where welding is difficult (producing conditions are severe), the sealing strength tends to decrease, and as a result, the pressure resistance strength may decrease.

On the other hand, in the present embodiment as illustrated in FIG. 5, the step D is provided between the first welding region R1 and the second welding region R2 in the vicinity of the welding region of the spout 20, and therefore, when heat is applied to a portion of each laminated film 16 located at a portion (step D) below the spout 20, the portion of each laminated film 16 having a mono-material configuration is softened and deformed so as to be narrowed inward. The laminated film 16 has such a recessed (narrowed) configuration, and therefore, even when the contents are stored in the packaging bag and pressure is applied, the pressure is less likely to be applied to a portion (an end portion of the spout, first welding region R1) where each sealant layer 18 is welded to the spout 20, and the pressure is applied to a portion (second welded region R2) where the sealant layers 18 are welded to each other as illustrated in (b) of FIG. 7. That is, with the configuration in which the laminated films 16 are recessed inward, the pressure of the contents (liquid) is guided toward the second welding region R2. Therefore, according to the spouted packaging bag 1, the pressure resistance strength can be improved even when the laminated film having a mono-material configuration is used.

Next, a method for producing the spouted packaging bag 1 will be described. In this producing method, first, a plurality of laminated films 16 each having the base material 17 and the sealant layer 18 made of the same material are prepared. Each of the laminated films 16 includes a portion having a shape (for example, a rectangular shape) corresponding to the outer shape of the storage portion 10 of the spouted packaging bag 1. In addition, the spout 20 having the spout tube 21 and the base 22 provided on one end side of the spout tube 21 is prepared. Then, the base 22 of the spout 20 is disposed on the sealant layer 18 corresponding to the upper end portion 11 of one laminated film 16, and the sealant layer 18 corresponding to the upper end portion 11 of the other laminated film 16 is disposed from above the base 22 of the spout 20. As a result, the spout 20 is disposed to be sandwiched between the laminated films 16. Thereafter, by heat-sealing a portion corresponding to the upper end portion 11, each sealant layer 18 of the laminated film 16 is welded to the base 22 of the spout 20, and the sealant layers 18 are welded to each other at the side of the base 22. At this time, the above welding may be performed simultaneously with welding the lower end portion 12 and the side portions 13 and 14, or the above welding may be performed at different timings. Note that when the spouted packaging bag 1 is a standing pouch, welding may be performed by disposing a bottom film (having a layer configuration same as that of the laminated film 16) folded in two on the lower end side in addition to the pair of laminated films 16. The heat-sealing temperature is a temperature equal to or higher than the melting point of the sealant layer 18, and is, for example, in a range of 120 to 170° C. In addition, in the method for producing the spouted packaging bag 1 according to the present embodiment, at the time of welding, welding is performed such that the width D1 of the first welding region R1 where each sealant layer 18 is welded to the base 22 is shorter than the width D2 of the second welding region R2 where the sealant layers 18 are welded to each other, and the step S is formed between the first welding region R1 and the second welding region R2.

As described above, in the spouted packaging bag 1 according to the present embodiment, the step S is provided between the first welding region R1 where each sealant layer 18 is welded to the base 22 of the spout 20 and the second welding region R2 where the sealant layers 18 are welded to each other. By providing such a step S, when heat is applied (at the time of producing) to the portion of each laminated film 16 located at the portion (step S) below the spout 20, the film portion is softened and deformed so as to be narrowed inward (see FIG. 5). Then, each laminated film 16 has such a recessed configuration, and therefore, when the contents are stored in the packaging bag, the pressure of the contents which should be applied to the portion (the end portion of the spout) where each sealant layer 18 is welded to the spout 20 is less likely to be applied, the stress is dispersed in portions other than the portion, and the pressure is guided toward the region where the sealant layers 18 located at the side of the spout are welded to each other (see (b) of FIG. 7). The second welding region R2 of the sealant layers 18 has a higher sealing strength than the first welding region R1 where each sealant layer 18 is welded to the spout 20 (base 22). Therefore, according to the spouted packaging bag 1, the pressure resistance strength can be improved even when the laminated film having a mono-material configuration is used.

In the spouted packaging bag 1 according to the present embodiment, the size of the step S along the vertical direction may be 1.5 mm or more. In this case, the portion of each laminated film 16 located at the portion (step S) below the spout 20 can be more reliably deformed so as to be narrowed inward to achieve pressure dispersion. Therefore, according to the spouted packaging bag 1, the pressure resistance strength can be more reliably improved even when the laminated film 16 having a mono-material configuration is used.

In the spouted packaging bag 1 according to the present embodiment, the size of the step S along the vertical direction may be 5 mm or less. The portion of the step S between the first welding region R1 where each sealant layer 18 is welded to the base 22 of the spout 20 and the second welding region R2 where the sealant layers 18 are welded to each other constitutes a flow path for pouring the contents stored in the storage portion 10 out of the spout tube 21 of the spout 20. As described above, the portion of each laminated film 16 corresponding to the step S is narrowed inward, and the flow path is narrowed. For this reason, in the spouted packaging bag 1, the length of the step S is set to 5 mm or less. Therefore, according to the spouted packaging bag 1, the contents stored in the packaging bag can be easily poured out.

In the spouted packaging bag 1 according to the present embodiment, the size of the step S along the vertical direction may be 0.15 to 0.6 with respect to the length of the base 22 along the vertical direction. In this case, since the size of the step S is 0.15 or more with respect to the length of the base 22, the portion of each laminated film 16 located at the portion (step S) below the spout 20 is deformed so as to be narrowed inward to achieve pressure dispersion in the same manner as described above, whereby the pressure resistance strength can be more reliably improved even when the laminated film 16 having a mono-material configuration is used. In addition, since the size of the step S is 0.6 or less with respect to the length of the base 22, it is possible to easily pour out the contents stored in the packaging bag without making the flow path too long in the same manner as described above.

In the spouted packaging bag 1 according to the present embodiment, the size of the step S along the vertical direction may be 0.1 to 0.5 with respect to the lateral width of the base 22 along the lateral direction orthogonal to the vertical direction. In this case, since the size of the step S is 0.1 or more with respect to the lateral width of the base 22, the portion of each laminated film 16 located at the portion (step S) below the spout 20 is deformed so as to be narrowed inward to achieve pressure dispersion in the same manner as described above, whereby the pressure resistance strength can be more reliably improved even when the laminated film 16 having a mono-material configuration is used. In addition, since the size of the step S is 0.5 or less with respect to the lateral width of the base 22, it is possible to easily pour out the contents stored in the packaging bag without making the flow path too long in the same manner as described above.

In the spouted packaging bag 1 according to the present embodiment, the same material constituting the base material 17 and the sealant layer 18 is preferably a polyethylene resin or a polypropylene resin. By using such a material, softening at the time of welding is easily promoted, and when heat is applied to the portion of each laminated film 16 located at the portion (step S) below the spout 20, the portion of the film can be more reliably deformed so as to be narrowed inward. As a result, the pressure resistance strength can be improved even when the laminated film having a mono-material configuration is used.

In the spouted packaging bag 1 according to the present embodiment, the same material constituting the base material 17 and the sealant layer 18 may be a polyethylene resin, and the content of the polyethylene resin in the entire laminated film 16 may be 90 mass % or more. In this case, softening at the time of welding is more easily accelerated, and when heat is applied to the portion of each laminated film 16 located at the portion (step S) below the spout 20, the portion of the film can be more reliably deformed so as to be narrowed inward. As a result, the pressure resistance strength can be improved even when the laminated film having a mono-material configuration is used.

In the spouted packaging bag 1 according to the present embodiment, the storage portion 10 is formed such that the sealant layers 18 facing each other are recessed inward at the step S between the first welding region R1 and the second welding region R2. In this case, even when the contents are stored in the packaging bag and pressure is applied, the pressure is less likely to be applied to the first welding region R1 (the end portion of the spout 20) where each sealant layer 18 is welded to the spout 20, and the pressure is dispersed so as to be applied to the portion where the sealant layers 18 are welded to each other. Therefore, according to the spouted packaging bag 1, the pressure resistance strength can be improved even when the laminated film having a mono-material configuration is used.

In the method for producing the spouted packaging bag 1 according to the present embodiment, in a step of welding, welding is performed such that the width D1 of the first welding region R1 where each sealant layer 18 is welded to the base 22 is shorter than the width D2 of the second welding region R2 where the sealant layers 18 are welded to each other, and the step S is formed between the first welding region R1 and the second welding region R2. By providing the step S in this manner, when heat is applied to the portion of the laminated film 16 located at the portion (step S) below the spout 20, the portion of the film is softened and deformed so as to be narrowed inward. The film has such a recessed configuration, and therefore, even when the contents are stored in the packaging bag and pressure is applied, the pressure is less likely to be applied to the first welding region R1 (the end portion of the spout 20) where each sealant layer 18 is welded to the spout 20, and the pressure is applied to the second welding region R2 where the sealant layers 18 are welded to each other. Therefore, according to the method for producing a spouted packaging bag, it is possible to obtain a packaging bag having improved pressure resistance strength even when the laminated film having a mono-material configuration is used.

In addition, when it is attempted to produce a spouted packaging bag in which a step is not provided as in the conventional configuration with the laminated film having a mono-material configuration, the producing conditions (condition range of a sealing temperature) for setting the sealing strength and the pressure resistance strength to predetermined values or more are extremely narrow (see also Comparative Example described later). For this reason, in the producing method with the conventional configuration, productivity can be reduced. However, according to the method for producing the spouted packaging bag 1 according to the present embodiment, since the bag configuration is easy to improve the pressure resistance strength, the range of the producing conditions for setting the sealing strength and the pressure-resistant strength to the predetermined values or more can be widened, so that it is possible to improve the productivity and also increase a non-defective product rate.

In the method for producing the spouted packaging bag according to the present embodiment, the width of the step S is preferably 1.5 mm to 5 mm. Since the width of the step S is 1.5 mm or more, the portion of each laminated film 16 located at the portion (step S) below the spout 20 can be more reliably deformed so as to be narrowed inward. As a result, according to the spouted packaging bag 1, the pressure resistance strength can be more reliably improved even when the laminated film 16 having a mono-material configuration is used. On the other hand, since the width of the step S is 5 mm or less, it is possible to easily pour out the contents stored in the packaging bag by limiting the length of the narrow flow path as described above.

Although the embodiment of the present invention has been described in detail above, the present invention is not limited to the above embodiment. For example, in the above embodiment, the spout 20 is provided at the center of the upper end portion 11 of the storage portion 10, but the present invention is not limited to such a configuration. For example, the spout 20 may be provided at a corner portion between the upper end portion 11 and the side portion 13 of the storage portion 10. Even with such a configuration, similar functions and effects can be achieved.

### EXAMPLES

Hereinafter, the contents of the present invention will be described in more detail with reference to Examples and Comparative Example, but the present invention is not limited to the following Examples.

### Example 1

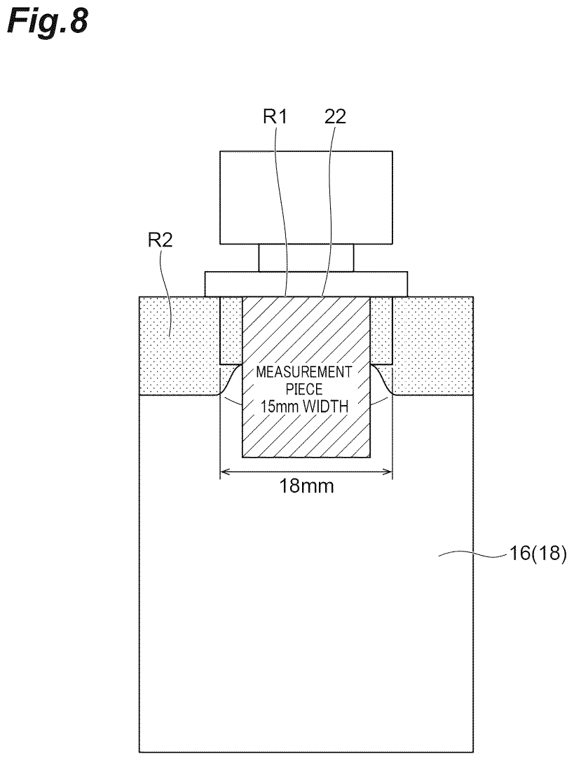

As Example 1, the spouted packaging bag 1 having the configuration illustrated in FIG. 1 and a test piece (see FIG. 8, measurement piece) corresponding to the vicinity of the welded portion of the spouted packaging bag 1 were made. In the spouted packaging bag 1 and the test piece, the size of the step S was 3 mm. In addition, the welding width of the first welding region R1 of the upper end portion 11 was 8 mm, and the welding width of the second welding region R2 was 12 mm. The first welding region R1 was formed slightly away from the flange 23 of the spout 20. Note that the lateral width of the base 22 of the spout 20 was 18 mm, and the lateral width of a welded portion in the test piece was 15 mm. The packaging bag and the test piece having such a configuration were made by welding the laminated films 16 at a reference sealing temperature and temperatures (±10° C., ±20° C., ±30° C.) shifted up and down from the reference sealing temperature. The sealing strength was evaluated using the made test piece. In addition, the pressure resistance strength was evaluated using the made packaging bag. The sealing strength and the pressure resistance strength were evaluated by the following methods.

### [Sealing Strength]

The test piece (see FIG. 8) provided with a welding region having a sample width of about 15 mm was prepared, and T-peel was performed at a pulling rate of 300 mm/min. This T-peel test was performed by a method in accordance with JIS K7127. In this test, when the strength was 10 N/15 mm or more and the peeling interface was a film cut, the test piece was rated A as a passed product. On the other hand, when the strength was less than 10 N/15 mm, or when the peeling interface was surface peeling between the film and the spout, the test piece was rated B as a failed product.

### [Pressure Resistance Test]

In the pressure resistance test, hot water at 50° C. was injected into the prepared spouted packaging bag 1, and an internal pressure of 80 kgf was applied for 3 minutes. In this test, when no leakage occurred, the spouted packaging bag 1 was rated A as a passed product. On the other hand, when leakage occurred, the spouted packaging bag 1 was rated B as a failed product.

Table 1 below shows the test results (Example 1) of the sealing strength and the pressure resistance strength when heat-sealing was performed at the reference sealing temperature (0 (reference temperature) below) and the temperatures shifted up and down from the reference sealing temperature.

TABLE 1

| Sealing Temperature | | Pressure Resistance |
|---|---|---|
| (° C.) | Sealing Strength | Strength |
| −30 | B | B |
| −20 | A | A |
| −10 | A | A |
| 0 (Reference | A | A |
| temperature) | | |
| 10 | A | A |
| 20 | A | A |
| 30 | B | B |

### Example 2

In Example 2, the spouted packaging bag 1 and the corresponding test piece (see FIG. 8) were made in the same manner as in Example 1 except that the size of the step S was 2 mm, and the sealing strength and the pressure resistance strength were evaluated. Note that in Example 2, the welding width of the first welding region R1 was 8 mm.

Table 2 below shows the test results (Example 2) of the sealing strength and the pressure resistance strength when heat-sealing was performed at the reference sealing temperature (0 (reference temperature) below) and the temperatures shifted up and down from the reference sealing temperature.

TABLE 2

| Sealing Temperature | | Pressure Resistance |
|---|---|---|
| (° C.) | Sealing Strength | Strength |
| −30 | B | B |
| −20 | B | A |
| −10 | A | A |
| 0 (Reference | A | A |
| temperature) | | |
| 10 | A | A |
| 20 | A | B |
| 30 | B | B |

### Comparative Example

In Comparative Example, the spouted packaging bag 101 (see FIG. 6) and a test piece corresponding to the spouted packaging bag 101 were made without providing the step S between the first welding region R1 and the second welding region R2. In the spouted packaging bag 101 and the test piece, there was no step S, the welding width of the first welding region R11 of the upper end portion 11 was 8 mm, and the welding width of the second welding region R12 was 8 mm. Note that the lateral width of the base 22 of the spout 20 was 18 mm, and the lateral width of a welded portion in the test piece was 15 mm. In Comparative Example, the sealing strength and the pressure resistance strength of the made packaging bag and test piece were evaluated in the same manner as in Examples 1 and 2.

Table 3 below shows the test results (Comparative Example) of the sealing strength and the pressure resistance strength when heat-sealing was performed at the reference sealing temperature (0 (reference temperature) below) and the temperatures shifted up and down from the reference sealing temperature.

TABLE 3

| Sealing Temperature | | Pressure Resistance |
|---|---|---|
| (° C.) | Sealing Strength | Strength |
| −30 | B | B |
| −20 | B | B |
| −10 | B | A |
| 0 (Reference | A | A |
| temperature) | | |
| 10 | B | B |
| 20 | B | B |
| 30 | B | B |

As can be seen from Example 1, Example 2, and Comparative Example, it has been confirmed that the sealing strength and the pressure resistance strength of the spouted packaging bag 1 can be easily increased by providing the step S between the first welding region R1 and the second welding region R2. In addition, it has been confirmed that in a case where a spout is welded without providing a step as in Comparative Example, the conditions of the sealing temperature are severe in order to set the sealing strength and the pressure resistance strength to predetermined values or more, and when a spouted packaging bag is made using a laminated film having a mono-material configuration, the non-defective product rate is lowered and the production efficiency is deteriorated. On the other hand, it has been found that by adopting the configuration in which the step S is provided as in the spouted packaging bag 1 according to the present embodiment, the range of conditions of the allowable sealing temperature in the case of making the packaging bag is widened. For this reason, according to this configuration, it has been confirmed that the non-defective product rate can be improved and the producing efficiency can be increased.

### REFERENCE SIGNS LIST

1 Spouted packaging bag
10 Storage portion
11 Upper end portion (edge portion)
16 Laminated film
17 Base material
18 Sealant layer
20 Spout
21 Spout tube
22 Base
D1, D2 Width
R1 First welding region
R2 Second welding region
R3 Recessed region
S Step

1. A spouted packaging bag comprising:
a storage portion made of laminated films each having a base material and a sealant layer that are made of the same material; and
a spout having a spout tube extending in a first direction and a base provided on one end side of the spout tube, the spout being attached to an edge portion of the storage portion,
wherein the sealant layer is welded to the base of the spout and the sealant layers are welded to each other at a side of the base at the edge portion of the storage portion,
wherein a width of a first welding region where the sealant layer is welded to the base, along the first direction, is shorter than a width of a second welding region where the sealant layers are welded to each other, along the first direction, and a step is formed between the first welding region and the second welding region.

2. The spouted packaging bag according to claim 1,
wherein a size of the step along the first direction is 1.5 mm or more.

3. The spouted packaging bag according to claim 1,
wherein a size of the step along the first direction is 5 mm or less.

4. The spouted packaging bag according to claim 1,
wherein a size of the step along the first direction is 0.15 to 0.6 with respect to a length of the base along the first direction.

5. The spouted packaging bag according to claim 1,
wherein a size of the step along the first direction is 0.1 to 0.5 with respect to a lateral width of the base along a second direction intersecting the first direction.

6. The spouted packaging bag according to claim 1,
wherein the same material constituting the base material and the sealant layer is a polyethylene resin or a polypropylene resin.

7. The spouted packaging bag according to claim 1,
wherein the same material constituting the base material and the sealant layer is a polyethylene resin, and a content of the polyethylene resin in the entire laminated films is 90 mass % or more.

8. The spouted packaging bag according to claim 1,
wherein the storage portion is formed such that the sealant layers facing each other are recessed inward at the step between the first welding region and the second welding region.

9. A method for producing a spouted packaging bag comprising:
preparing laminated films each having a base material and a sealant layer that are made of the same material;
preparing a spout having a spout tube and a base provided on one end side of the spout tube; and
welding the sealant layer of the laminated film to the base of the spout, and welding the sealant layers to each other at a side of the base,
wherein, in the welding, welding is performed such that a width of a first welding region where the sealant layer is welded to the base is shorter than a width of a second welding region where the sealant layers are welded to each other, and a step is formed between the first welding region and the second welding region.

10. The method for producing a spouted packaging bag according to claim 9,
wherein a width of the step is 1.5 mm to 5 mm.
